(19) United States
(12) Patent Application Publication
(10) Pub. No.: US 2022/0376507 A1
(43) Pub. Date: Nov. 24, 2022

(54) POWER CONTROL APPARATUS, POWER CONTROL METHOD AND PROGRAM

(71) Applicant: Nippon Telegraph and Telephone Corporation, Tokyo (JP)

(72) Inventors: Hiroshi INOUE, Musashino-shi, Tokyo (JP); Hidetoshi TAKADA, Musashino-shi, Tokyo (JP)

(21) Appl. No.: 17/771,545

(22) PCT Filed: Oct. 30, 2019
(86) PCT No.: PCT/JP2019/042640

§ 371 Date: Apr. 25, 2022

(51) Int. Cl. H02J 3/28; H02J 7/00; H01M 10/42; H01M 10/48; H01M 10/44

(52) U.S. Cl. CPC H02J 3/28; H02J 7/0048; H01M 10/425; H01M 10/482; H01M 10/441; H01M 2010/4271

(57) ABSTRACT

A power control device for controlling one or more secondary batteries for charging or discharging includes: a monitor unit configured to obtain an amount of power storage of each of the one or more secondary batteries; a secondary battery selection unit configured to select a secondary battery to be controlled from the one or more secondary batteries based on a target amount of power storage and an amount of power storage; and a secondary battery control unit configured to control a selected secondary battery.

### TECHNICAL FIELD

The present invention relates to a technique for controlling secondary batteries.

### BACKGROUND ART

Conventionally, power providers have adjusted electric power supply to keep balance of supply and demand. In recent years, a demand-response mechanism that controls power consumption on the demand side, which consumes electric power, and thereby contributes to the balance of supply and demand has been adopted.

For example, Non-Patent literature 1 discloses a technique in which an aggregator, who received a request of demand adjustment from the supply-side power providers gives instructions to adjust demand to the power consumers; accordingly, the consumers charge or discharge secondary batteries to adjust the demand for electric power.

### CITATION LIST

### Non-Patent Literature

Non-Patent Literature 1: Internet <URL: https://www.ngk.co.jp/product/nas/application/feature06/>, retrieved on Oct. 4, 2019

### SUMMARY OF THE INVENTION

### Technical Problem

In techniques such as described in Non-Patent Literature 1, a large number of secondary batteries are candidates for control targets. In this case, there is a possibility that secondary batteries with no charging/discharging capacity are selected as the control targets for charging/discharging requests.

For example, in a case where a secondary battery with a small amount of power storage is selected for a discharging request, the secondary battery cannot provide enough electric power. There is also a possibility that excessive discharge can result in exhaustive deterioration of the secondary battery.

An object of the present invention, which has been made in view of the above points, is to provide a technique that enables appropriate selection of a secondary battery as a control target for charging or discharging from one or more secondary batteries.

### Means for Solving the Problem

According to a disclosed technique, there is provided a power control device for controlling one or more secondary batteries for charging or discharging, the device including: a monitor unit configured to obtain an amount of power storage of each of the one or more secondary batteries; a secondary battery selection unit configured to select a secondary battery to be controlled from the one or more secondary batteries based on a target amount of power storage and an amount of power storage; and a secondary battery control unit configured to control a selected secondary battery.

### Effects of the Invention

According to the disclosure, a technique that enables appropriate selection of a secondary battery as a control target for charging or discharging from one or more secondary batteries can be provided.

### BRIEF DESCRIPTION OF DRAWINGS

FIG. 1 is a diagram showing an overall configuration of a system in an embodiment of the present invention.

FIG. 2 is a configuration diagram of a secondary battery.

FIG. 3 is a diagram showing an example of a hardware configuration of a power control device.

FIG. 4 is a flowchart for illustrating operation of the power control device.

FIG. 5 is a diagram for illustrating an example of a method of selecting secondary batteries to be controlled in the case of a charging request.

FIG. 6 is a diagram for illustrating an example of a method of selecting secondary batteries to be controlled in the case of a charging request.

FIG. 7 is a diagram for illustrating an example of a method of selecting secondary batteries to be controlled in the case of a discharging request.

FIG. 8 is a diagram for illustrating an example of a method of selecting secondary batteries to be controlled in the case of a discharging request.

### DESCRIPTION OF EMBODIMENTS

Hereinafter, an embodiment of the present invention (the embodiment) will be described with reference to the drawings. The embodiment described below is merely an example, and embodiments to which the present invention is applied are not limited to the following embodiment.

### System Configuration and Device Configuration

<Overall Configuration>

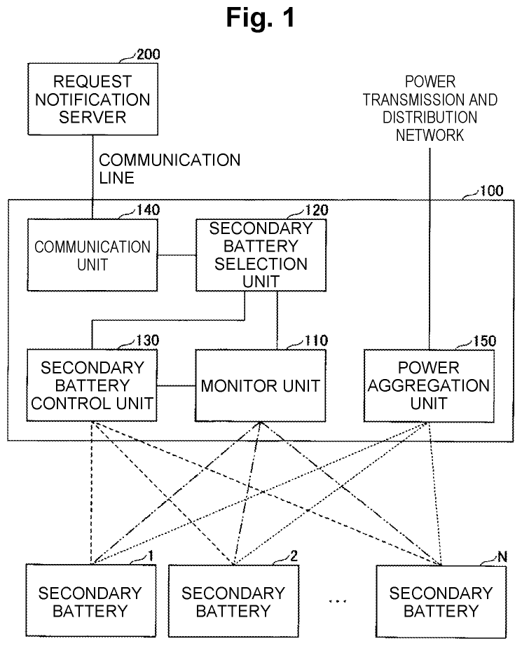

FIG. 1 shows an overall configuration of a system in the embodiment. As shown in FIG. 1, the system includes a request notification server 200, a power control device 100, and secondary batteries 1 to N.

The request notification server 200 is a server of power providers and the like, and transmits a request for increasing demand for power or a request for decreasing demand for power to the power control device 100.

More specifically, in the embodiment, the request for increasing the demand for power is the charging request. The charging request may include the amount of power of the requested charging. The request for decreasing the demand for power is the discharging request. The discharging request may include the amount of power of the requested discharging.

The power control device 100 is connected to the request notification server 200 by a communication line and controls the secondary batteries 1 to N (N is an integer equal to or larger than 1) based on the request from the request notification server 200 to provide electric power responsive to the request to a power transmission and distribution network, or to receive electric power responsive to the request. The power control device 100 may be called a VPP (virtual power plant) device.

The secondary batteries 1 to N may be provided to respective different consumers, one large consumer, or in other forms.

<Configuration of Power Control Device>

As shown in FIG. 1, the power control device 100 includes a monitor unit 110, a secondary battery selection unit 120, a secondary battery control unit 130, a communication unit 140, and a power aggregation unit 150.

The communication unit 140 receives a request transmitted from the request notification server 200 and notifies the secondary battery selection unit 120 of the received request.

The monitor unit 110 retains a target amount of power storage of each secondary battery, obtains the amount of power storage of each secondary battery on a regular basis, calculates a deviation ratio between the target amount of power storage and the actual amount of power storage for each secondary battery, and outputs the deviation ratio to the secondary battery selection unit 120. Note that it may also be possible that the monitor unit 110 notifies the secondary battery selection unit 120 of the amount of power storage of each secondary battery, and the secondary battery selection unit 120 calculates the deviation ratio between the target amount of power storage and the actual amount of power storage.

The target amount of power storage is the optimal amount of power storage as the amount of power storage of the secondary battery and is preset for each secondary battery. For example, the target amount of power storage is the amount of power storage that can afford to charge or discharge.

The deviation ratio is a value of a ratio of the difference between the target amount of power storage and the amount of power storage to a total capacity regarded as 100. For example, assuming that a secondary battery has a total capacity of 100 kWh, a target amount of power storage of 70 kWh, and an amount of power storage of 40 kWh at a point in time, the deviation ratio at that point in time is 0.3 (=(70-40)/100). Note that the value representing deviation between the target amount of power storage and the amount of power storage (referred to as a deviation degree) is not limited to the above-described deviation ratio.

The secondary battery selection unit 120 selects secondary batteries to be controlled for charging or discharging based on the request received from the communication unit 140 and the deviation ratio and notifies the secondary battery control unit 130 of the selection results and control contents.

With regard to the selection method, the secondary battery selection unit 120 basically selects the secondary batteries with the amount of power storage larger than the target amount of power storage as the control targets for discharging, and the secondary batteries with the amount of power storage smaller than the target amount of power storage as the control targets for charging.

In addition, with regard to the priority in selection, the priority is higher as the deviation ratio is higher. For example, in the case where a discharging request is received, the secondary batteries with the actual amount of power storage that is excessively higher than the target amount of power storage are more likely to be selected. In the case where a charging request is received, the secondary batteries with the actual amount of power storage that is excessively lower than the target amount of power storage are more likely to be selected. The details of the selection method will be described later.

Based on the selection results and control contents received from the secondary battery selection unit 120, the secondary battery control unit 130 instructs the secondary batteries that have been the control targets to be discharged or charged.

In the case of discharging, the power aggregation unit 150 aggregates electric power input from the secondary batteries and outputs thereof to the power transmission and distribution network. In the case of charging, the power aggregation unit 150 receives electric power from the power transmission and distribution network and supplies the electric power to the secondary batteries to be charged.

<Configuration of Secondary Battery>

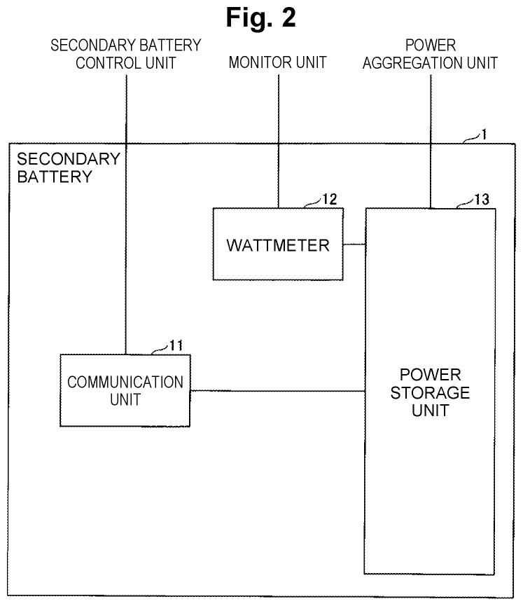

Since the plural secondary batteries 1 to N have the same configuration, the configuration of the secondary battery 1 is shown in FIG. 2 as a representative. As shown in FIG. 2, the secondary battery 1 includes a communication unit 11, a wattmeter 12, and a power storage unit 13.

The communication unit 11 receives instructions from the secondary battery control unit 130, and, based on the instructions, instructs the power storage unit 13 to be discharged or charged.

The wattmeter 12 measures the amount of power storage in the power storage unit 13 and outputs thereof to the monitor unit 110 on a regular basis. The amount of power storage can be obtained by measuring the voltage of the power storage unit 13.

The power storage unit 13 outputs electric power to the power aggregation unit 150 in the case where the discharging instruction is received from the communication unit 11 and receives electric power from the power aggregation unit 150 to be charged in the case where the charging instruction is received from the communication unit 11.

<Hardware Configuration Example>

A part of the power control device 100 that is made up of the monitor unit 110, the secondary battery selection unit 120, the secondary battery control unit 130, and the communication unit 140 can be implemented by, for example, causing a computer to execute programs that describe the processing contents of these functional units. Note that this “computer” can be a virtual machine on the cloud. In the case of using the virtual machine, the “hardware” described here is virtual hardware. The part that is made up of the monitor unit 110, the secondary battery selection unit 120, the secondary battery control unit 130, and the communication unit 140 may be called the power control device.

The above programs can be recorded on a computer-readable recording medium (a portable memory or the like) to be stored or distributed. In addition, it is also possible to provide the above programs through networks, such as the Internet or e-mail.

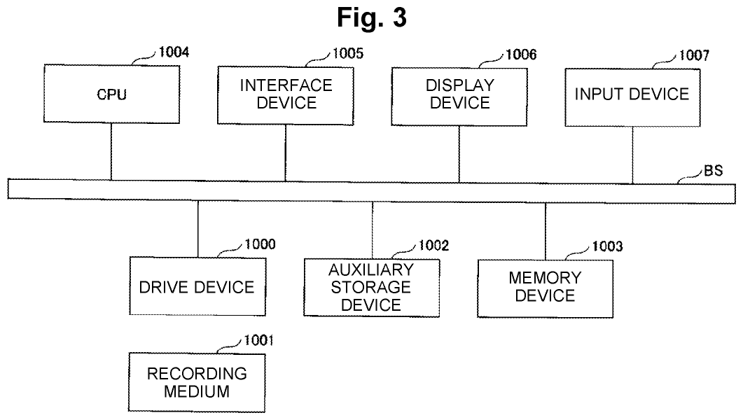

FIG. 3 is a diagram showing an example of a hardware configuration of the above-described computer. The computer in FIG. 3 includes a drive device 1000, an auxiliary storage device 1002, a memory device 1003, a CPU 1004, an interface device 1005, a display device 1006, an input device 1007, and so forth that are connected to one another via a bus B.

The programs implementing the processing in the computer are provided by, for example, a recording medium 1001, such as a CD-ROM or a memory card. When the recording medium 1001 storing the programs is set to the drive device 1000, the programs are installed from the recording medium 1001 to the auxiliary storage device 1002 via the drive device 1000. However, the programs are not necessarily be installed from the recording medium 1001 and may be downloaded from other computers via a network. The auxiliary storage device 1002 stores the installed programs, as well as necessary files, data, and the like.

When an instruction to start the programs is provided, the memory device 1003 reads the programs from the auxiliary storage device 1002 and stores thereof. The CPU 1004 executes the functions related to the device in accordance with the programs stored in the memory device 1003. The interface device 1005 is used as an interface to connect to the network. The display device 1006 displays GUI (graphical user interface) by the programs. The input device 1007 is constituted by a keyboard, a mouse, buttons, or a touch panel, etc., and used to input various operating instructions.

(Operation Example of Power Control Device)

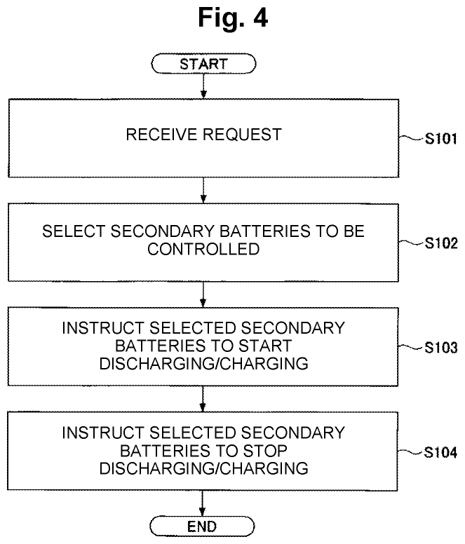

Hereinafter, an operation example of the power control device 100 will be described according to procedures in a flowchart in FIG. 4. As a presumption, the monitor unit 110 obtains the amount of power storage in each secondary battery on a regular basis, calculates the deviation ratio for each secondary battery, and notifies the secondary battery selection unit 120 of the deviation ratio. Alternatively, the secondary battery selection unit 120 retains the target amount of power storage of each secondary battery, and after obtaining the amount of power storage in each secondary battery on a regular basis, the monitor unit 110 notifies the secondary battery selection unit 120 of the amount of power storage, and thereby the secondary battery selection unit 120 calculates the deviation ratio of each secondary battery.

In S101, the communication unit 140 receives a request from the request notification server 200 and notifies the secondary battery selection unit 120 of the request.

In S102, in response to the request from the request notification server 200, the secondary battery selection unit 120 selects one or more secondary batteries to be controlled based on the deviation ratio of each secondary battery and notifies the secondary battery control unit 130 of the one or more secondary batteries selected as the control targets and the control contents for each secondary battery. The details of the selection method of the secondary batteries will be described later.

The above control contents are, for example, the charging instruction or discharging instruction. Moreover, in the case of charging, in addition to the charging instruction, the amount of power to be charged, the amount of power storage of the charging objective (the amount of power storage after charging), or the charging time may be included in the control contents. In the case of discharging, in addition to the discharging instruction, the amount of power to be discharged, the amount of power storage of the discharging objective (the amount of power storage after discharging), or the discharging time may be included in the control contents.

In S103, the secondary battery control unit 130 instructs each secondary battery to be controlled to start discharging or start charging.

In S104, when the secondary battery control unit 130 is notified by the monitor unit 110 that the objective amount of power storage has been achieved in the secondary battery to be controlled, for example, the secondary battery control unit 130 instructs the secondary battery to stop discharging or stop charging.

Note that, in the following case, instead of performing the above control, in S103, it may be possible that the secondary battery control unit 130 notifies start of discharging or start of charging, the objective amount of power storage, time, etc., and S104 is not performed. The “following case” means a case in which the secondary battery itself has a function to stop charging/discharging when the objective amount of power storage is achieved, or when the instructed time has elapsed.

The control of start/stop of charging/discharging by the secondary battery control unit 130 may be performed on the secondary batteries one by one, or on plural secondary batteries collectively. Controlling the secondary batteries one by one is, after controlling the start and stop of charging/discharging for one secondary battery is finished, to control the start and stop of charging/discharging for the next secondary battery.

In addition, in the embodiment, control of the secondary battery is performed based on the request from the request notification server 200; however, even if there is no request, the secondary battery may be controlled autonomously.

(Details of Secondary Battery Selection Method)

Hereinafter, details of the secondary battery selection method will be described in the case of charging request and the case of discharging request separately. In the following description, for the sake of convenience, positive and negative of the deviation ratio are assumed as below.

In the case of the charging request, it is assumed that the deviation ratio is positive when the amount of power storage is smaller than the target amount of power storage, and in the case of the discharging request, the deviation ratio is positive when the amount of power storage is larger than the target amount of power storage. In other words, based on the target amount of power storage, the deviation ratio is assumed to be positive when the amount of power storage is on the side where it is easy for the amount to meet the request. In addition, in the following description, K and M are both integers equal to or larger than 1.

<Case of Charging Request>

For example, in the case where the secondary battery selection unit 120 receives a charging request specifying the amount P of power to be charged, the secondary battery selection unit 120 first selects, from among the secondary batteries 1 to N, all the secondary batteries with the amount of power storage smaller than the target amount of power storage. The secondary battery selected here is denoted as a secondary battery A. The selected K secondary batteries are assumed to be the secondary battery A_1 to the secondary battery A_K.

If it is assumed that the sum of the “target amount of power storage— amount of power storage” for the secondary batteries A_1 to A_K is equal to or larger than P, the secondary battery selection unit 120 selects the secondary batteries A from among the secondary batteries A_1 to A_K until the sum of the “target amount of power storage— amount of power storage” reaches P in order of the magnitude of the deviation ratio. In other words, the secondary battery selection unit 120 first selects the secondary battery A with the largest deviation ratio, and next selects the secondary battery A with the second largest deviation ratio, . . . , until the sum of the “target amount of power storage— amount of power storage” reaches P. Note that, for the sake of convenience, it is assumed that the sum becomes just P.

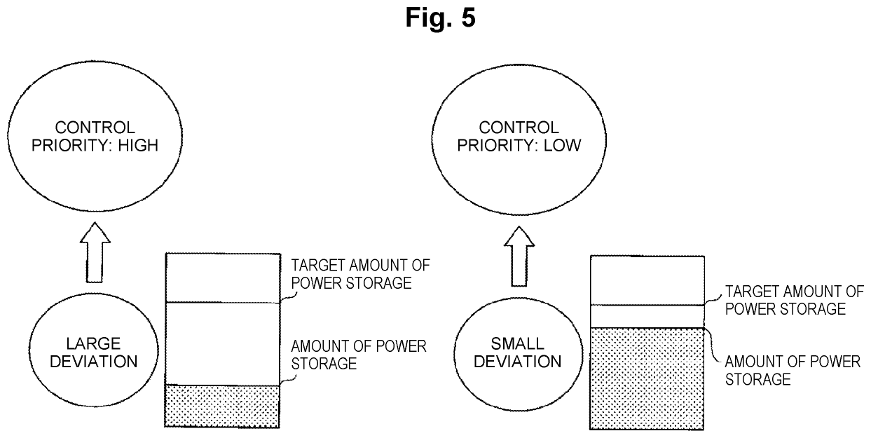

As described above, an image of preferentially selecting the secondary batteries with larger deviation ratio is shown in FIG. 5. As shown in FIG. 5, the priority is higher as the deviation ratio is larger.

As a result of the above, in the case where M secondary batteries A_1 to A_M are selected, the secondary battery selection unit 120 notifies the secondary battery control unit 130, for example, of the instruction to “charge each of the secondary batteries A_1 to A_M to the target amount of power storage”. The secondary battery control unit 130 performs charging control on the secondary batteries A_1 to A_M in accordance with the instruction.

Next, the case where the sum of the “target amount of power storage— amount of power storage” for the secondary batteries A_1 to A_K is less than P will be described. The control in the case where the sum of the “target amount of power storage— amount of power storage” for the secondary batteries A_1 to A_K is less than P includes the following (1) Example 1 and (2) Example 2.

### (1) Example 1

In Example 1, the secondary battery selection unit 120 selects all the secondary batteries A_1 to A_K as the control targets, and no more secondary batteries are selected. This example has the advantage that, though the requested amount P cannot be satisfied, the secondary batteries falling outside the range of the target amount of power storage can be reduced.

### (2) Example 2

In example 2, a charging limit, which is the value of the amount of power storage larger than the target amount of power storage, is preset for each secondary battery, and the charging limit is retained for each secondary battery by the secondary battery selection unit 120.

First, the secondary battery selection unit 120 selects all the secondary batteries A_1 to A_K as the control target. If it is assumed that the sum of the “target amount of power storage— amount of power storage” for the secondary batteries A_1 to A_K is S, at the time when the secondary battery selection unit 120 selects all the secondary batteries A_1 to A_K as the control target, there is insufficient charging amount “P-S”; therefore, the secondary battery selection unit 120 selects the secondary batteries to charge the amount of power “P-S” from among the secondary batteries 1 to N based on the charging limit.

Basically, the secondary battery with the amount of power storage that largely deviates from the charging limit is preferentially selected. On the assumption that the amount of power storage of the secondary batteries A_1 to A_K from among the secondary batteries 1 to N at this time is the target amount of power storage, the secondary battery selection unit 120 makes a selection for charging “P-S”.

Here, (charging limit— amount of power storage)/total capacity is referred to as a second deviation ratio. The secondary battery selection unit 120 selects the secondary batteries from among the secondary batteries 1 to N until the sum of the “charging limit— amount of power storage” reaches “P-S” in order of the magnitude of the second deviation ratio. The secondary battery selected here is referred to as a secondary battery B. In other words, the secondary battery selection unit 120 first selects the secondary battery B with the largest second deviation ratio, and next selects the secondary battery B with the second largest second deviation ratio, . . . , until the sum of the “charging limit— amount of power storage” reaches “P-S”. Note that the secondary battery selection unit 120 may make an arbitrary selection among the secondary batteries with the same “charging limit— amount of power storage”.

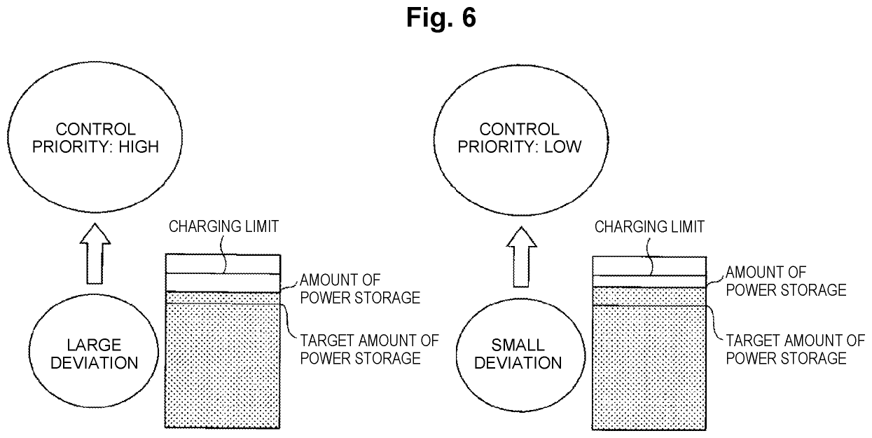

As described above, an image of preferentially selecting the secondary batteries with larger second deviation ratio is shown in FIG. 6. As shown in FIG. 6, the secondary battery with the larger second deviation ratio has higher priority.

As a result of the above selection, the secondary batteries selected as “secondary batteries A and B” or “secondary batteries B” are charged to the charging limit, whereas the secondary batteries selected as “secondary batteries A” are charged to the target amount of power storage.

Note that, in the case where, when selecting the first secondary battery A, there are no secondary batteries with the amount of power storage that is smaller than the target amount of power storage among the secondary batteries 1 to N, the secondary battery selection unit 120 may determine that there are no secondary batteries for the control target.

Alternatively, the secondary battery selection unit 120, similar to the above Example 2, may allow charging up to the charging limit and select the secondary batteries to be controlled.

<Case of Discharging Request>

For example, in the case where the secondary battery selection unit 120 receives a discharging request specifying the amount P of power to be discharged, the secondary battery selection unit 120 selects, first, from among the secondary batteries 1 to N, all the secondary batteries with the amount of power storage larger than the target amount of power storage. The secondary battery selected here is denoted as a secondary battery C. The selected K secondary batteries are assumed to be the secondary battery C_1 to the secondary battery C_K.

If it is assumed that the sum of the “amount of power storage— target amount of power storage” for the secondary batteries C_1 to C_K is equal to or larger than P, the secondary battery selection unit 120 selects the secondary batteries C from among the secondary batteries C_1 to C_K until the sum of the “amount of power storage-target amount of power storage” reaches P in order of the magnitude of the deviation ratio. In other words, the secondary battery selection unit 120 first selects the secondary battery C with the largest deviation ratio, and next selects the secondary battery C with the second largest deviation ratio, . . . , until the sum of the “amount of power storage— target amount of power storage” reaches P. Note that, for the sake of convenience, it is assumed that the sum becomes just P.

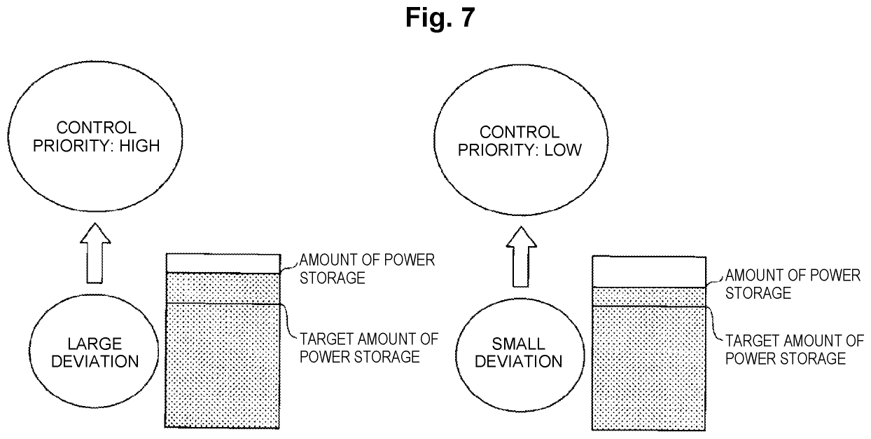

As described above, an image of preferentially selecting the secondary batteries with larger deviation ratio is shown in FIG. 7. As shown in FIG. 7, the priority is higher as the deviation ratio is larger.

As a result of the above, in the case where M secondary batteries C_1 to C_M are selected, the secondary battery selection unit 120 notifies the secondary battery control unit 130, for example, of the instruction to “discharge each of the secondary batteries C_1 to C_M to the target amount of power storage”. The secondary battery control unit 130 provides discharging instruction to the secondary batteries C_1 to C_M in accordance with the instruction.

Next, the case where the sum of the “amount of power storage— target amount of power storage” for the secondary batteries C_1 to C_K is less than P will be described. The control in the case where the sum of the “amount of power storage— target amount of power storage” for the secondary batteries C_1 to C_K is less than P includes the following (1) Example 1 and (2) Example 2.

### (1) Example 1

In Example 1, the secondary battery selection unit 120 selects all the secondary batteries C_1 to C_K as the control target, and no more secondary batteries are selected. This example has the advantage that, though the requested amount P cannot be satisfied, the secondary batteries that fall outside the range of the target amount of power storage can be reduced.

### (2) Example 2

In example 2, a discharging limit, which is the value of the amount of power storage smaller than the target amount of power storage, is preset for each secondary battery, and the discharging limit is retained for each secondary battery by the secondary battery selection unit 120.

It is assumed that the sum of the “amount of power storage— target amount of power storage” for the secondary batteries C_1 to C_K is S. At the time when the secondary battery selection unit 120 selects all the secondary batteries C_1 to C_K as the control target, there is insufficient discharging amount “P-S”; therefore, the secondary battery selection unit 120 selects the secondary batteries to discharge the amount of power “P-S” from among the secondary batteries 1 to N based on the discharging limit.

Basically, the secondary battery with the amount of power storage that largely deviates from the discharging limit is preferentially selected. On the assumption that the amount of power storage of the secondary batteries C_1 to C_K from among the secondary batteries 1 to N at this time is the target amount of power storage, the secondary battery selection unit 120 makes a selection for “P-S”.

Here, (amount of power storage— discharging limit)/total capacity is referred to as a second deviation ratio. The secondary battery selection unit 120 selects the secondary batteries from among the secondary batteries 1 to N until the sum of the “amount of power storage— discharging limit” reaches “P-S” in order of the magnitude of the second deviation ratio. The secondary battery selected here is referred to as a secondary battery D. In other words, the secondary battery selection unit 120 first selects the secondary battery D with the largest second deviation ratio, and next selects the secondary battery D with the second largest second deviation ratio, . . . , until the sum of the “amount of power storage— discharging limit” reaches “P-S”. Note that the secondary battery selection unit 120 may make an arbitrary selection among the secondary batteries with the same “amount of power storage— discharging limit”.

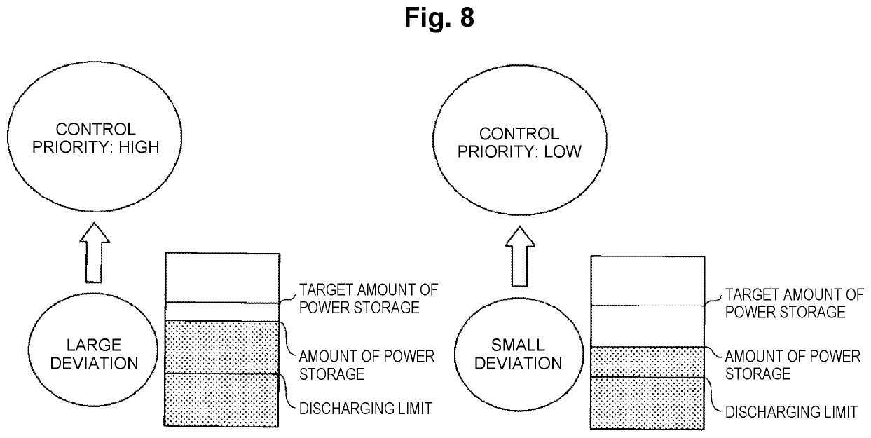

As described above, an image of preferentially selecting the secondary batteries with larger second deviation ratio is shown in FIG. 8. As shown in FIG. 8, the secondary battery with the larger second deviation ratio has higher priority.

As a result of the above selection, the secondary batteries selected as “secondary batteries C and D” or “secondary batteries D” are discharged to the discharging limit, whereas the secondary batteries selected as “secondary batteries C” are discharged to the target amount of power storage.

Note that, in the case where, when selecting the first secondary battery C, there are no secondary batteries with the amount of power storage that is larger than the target amount of power storage among the secondary batteries 1 to N, the secondary battery selection unit 120 may determine that there are no secondary batteries for the control target.

Alternatively, the secondary battery selection unit 120, similar to the above Example 2, may allow discharging up to the discharging limit and select the secondary batteries to be controlled.

### Effects of Embodiment

According to the technique described above, the power control device 100 can appropriately select the secondary batteries to be controlled so as to respond to requests. In addition, since the amount of power storage of secondary batteries 1 to N is controlled to approach the target amount of power storage, it is also effective in preventing deterioration of secondary batteries 1 to N.

### Conclusion of Embodiment

As explained above, in the embodiment, the power control device, power control method, and a program described in each of the following articles are at least provided.

### (Article 1)

A power control device for controlling one or more secondary batteries for charging or discharging, the device including:

a monitor unit configured to obtain an amount of power storage of each of the one or more secondary batteries;

a secondary battery selection unit configured to select a secondary battery to be controlled from the one or more secondary batteries based on a target amount of power storage and an amount of power storage; and a secondary battery control unit configured to control a selected secondary battery.

### (Article 2)

The power control device according to article 1, further including:

a communication unit configured to receive a request from a server, wherein the secondary battery selection unit selects a secondary battery to be controlled for charging or discharging based on the request.

### (Article 3)

The power control device according to article 1 or 2, wherein

the secondary battery selection unit selects a secondary battery with an amount of power storage larger than a target amount of power storage as a control target for discharging, and a secondary battery with an amount of power storage smaller than a target amount of power storage as a control target for charging.

### (Article 4)

The power control device according to any one of articles 1 to 3, wherein the secondary battery selection unit determines priority in selecting a secondary battery based on a deviation degree between a target amount of power storage and an amount of power storage.

### (Article 5)

The power control device according to any one of articles 1 to 4, wherein the secondary battery selection unit selects a secondary battery with an amount of power storage larger than a target amount of power storage and smaller than a charging limit as a control target for charging, and a secondary battery with an amount of power storage smaller than a target amount of power storage and larger than a discharging limit as a control target for discharging.

### (Article 6)

A power control method performed by a power control device to control one or more secondary batteries for charging or discharging, the method including:

a step of obtaining an amount of power storage of each of the one or more secondary batteries;

a step of selecting a secondary battery to be controlled from the one or more secondary batteries based on a target amount of power storage and an amount of power storage; and

a step of controlling a selected secondary battery.

### (Article 7)

A program causing a computer to function as each component in the power control device according to any one of articles 1 to 5.

So far, the embodiment has been described, but it is not intended to limit the present invention to the specific embodiment. Various kinds of modifications and variations can be made within the scope of the gist of the present invention defined by the following claims.

### REFERENCE SIGNS LIST

1 to N Secondary battery
11 Communication unit
12 Wattmeter
13 Power storage unit
100 Power control device
110 Monitor unit
120 Secondary battery selection unit
130 Secondary battery control unit
140 Communication unit
150 Power aggregation unit
200 Request notification server
1000 Drive device
1001 Recording medium
1002 Auxiliary storage device
1003 Memory device
1004 CPU
1005 Interface device
1006 Display device
1007 Input device

1. A power control device for controlling one or more secondary batteries for charging or discharging, the device comprising:
a monitor unit, including one or more processors, configured to obtain an amount of power storage of each of the one or more secondary batteries;
a secondary battery selection unit, including one or more processors, configured to select a secondary battery to be controlled from the one or more secondary batteries based on a target amount of power storage and an amount of power storage; and
a secondary battery control unit, including one or more processors, configured to control a selected secondary battery.

2. The power control device according to claim 1, further comprising:
a communication unit, including one or more processors, configured to receive a request from a server, wherein
the secondary battery selection unit is configured to select a secondary battery to be controlled for charging or discharging based on the request.

3. The power control device according to claim 1,
wherein
the secondary battery selection unit is configured to select a secondary battery with an amount of power storage larger than a target amount of power storage as a control target for discharging, and a secondary battery with an amount of power storage smaller than a target amount of power storage as a control target for charging.

4. The power control device according to claim 1, wherein
the secondary battery selection unit is configured to determine priority in selecting a secondary battery based on a deviation degree between a target amount of power storage and an amount of power storage.

5. The power control device according to claim 1, wherein
the secondary battery selection unit is configured to select a secondary battery with an amount of power storage larger than a target amount of power storage and smaller than a charging limit as a control target for charging, and a secondary battery with an amount of power storage smaller than a target amount of power storage and larger than a discharging limit as a control target for discharging.

6. A power control method performed by a power control device to control one or more secondary batteries for charging or discharging, the method comprising:
obtaining an amount of power storage of each of the one or more secondary batteries;
selecting a secondary battery to be controlled from the one or more secondary batteries based on a target amount of power storage and an amount of power storage; and
controlling a selected secondary battery.

7. A non-transitory computer readable medium storing a program causing a computer to function as a power control device to control one or more secondary batteries for charging or discharging, and to perform:
obtaining an amount of power storage of each of the one or more secondary batteries;
selecting a secondary battery to be controlled from the one or more secondary batteries based on a target amount of power storage and an amount of power storage; and
controlling a selected secondary battery.

8. The non-transitory computer readable medium according to claim 7, wherein the stored program causes the computer to further perform:
receiving a request from a server; and
selecting a secondary battery to be controlled for charging or discharging based on the request.

9. The non-transitory computer readable medium according to claim 7, wherein the stored program causes the computer to further perform:
selecting a secondary battery with an amount of power storage larger than a target amount of power storage as a control target for discharging, and a secondary battery with an amount of power storage smaller than a target amount of power storage as a control target for charging.

10. The non-transitory computer readable medium according to claim 7, wherein the stored program causes the computer to further perform:
determining priority in selecting a secondary battery based on a deviation degree between a target amount of power storage and an amount of power storage.

11. The power control method according to claim 6, further comprising:
receiving a request from a server; and
selecting a secondary battery to be controlled for charging or discharging based on the request.

12. The power control method according to claim 6, further comprising:
selecting a secondary battery with an amount of power storage larger than a target amount of power storage as a control target for discharging, and a secondary battery with an amount of power storage smaller than a target amount of power storage as a control target for charging.

13. The power control method according to claim 6, further comprising:
determining priority in selecting a secondary battery based on a deviation degree between a target amount of power storage and an amount of power storage.
